(19) United States
(12) Patent Application Publication
(10) Pub. No.: US 2024/0142953 A1
(43) Pub. Date: May 2, 2024

(54) PROCESS ESTIMATION DEVICE AND PROCESS ESTIMATION METHOD

(71) Applicant: Proterial, Ltd., Tokyo (JP)

(72) Inventor: Takeshi NISHIUCHI, Tokyo (JP)

(21) Appl. No.: 18/385,613

(22) Filed: Oct. 31, 2023

(30) Foreign Application Priority Data
Nov. 1, 2022 (JP) 2022-175875

(51) Int. Cl. G05B 19/418

(52) U.S. Cl. CPC G05B 19/4184; G05B 19/4183

(57) ABSTRACT

A process estimation device using a computer is provided with a regression model creation processing unit that, in manufacturing a product through a plurality of manufacturing processes, defines a given manufacturing process, excluding a first manufacturing process, as a target process to be subject to process estimation, learns a relationship between at least a processing object data indicating a state of a processing object to be processed in the target process, a processed object data indicating a state of a processed object processed in the target process, a device condition data indicating a state of a device used for processing in the target process before processing, and a process data indicating a set value of manufacturing conditions of the target process by machine learning, and creates a regression model representing a correlation between the data, and a process estimation processing unit that estimates the process data to be estimated using the regression model created by the regression model creation processing unit. A computer-performed process estimation method includes defining the manufacturing process as the target, learning the relationship between at least the processing object data, the device condition data, the process data, creating the regression model, and estimating the process data using the regression model.

### CROSS-REFERENCE TO RELATED APPLICATIONS

The present patent application claims the priority of Japanese patent application No. 2022-175875 filed on Nov. 1, 2022, and the entire contents thereof are hereby incorporated by reference, the entire contents of which are incorporated herein by reference.

### TECHNICAL FIELD

The present invention relates to a process estimation device and a process estimation method to estimate a process in the manufacturing of a material, more particularly, to a process estimation device using a computer and a computer-performed process estimation method to estimate the process in the manufacturing of the material.

### BACKGROUND OF THE INVENTION

In recent years, so-called “Materials Informatics”, which uses information science such as data mining to search for new and alternative materials efficiently, has attracted attention. In Japan, material development through so-called “Materials Integration” is also being studied. “Materials Integration” is defined as a comprehensive materials technology tool that aims to support materials research and development by integrating scientific technologies such as theory, experiment, analysis, simulation, and database, into materials science achievements.

Patent Literature 1 discloses collecting the manufacturing conditions and control values of each manufacturing device and the inspection results of manufactured products by each manufacturing device, determining cause-and-effect relationships, and adjusting process parameters.

### CITATION LIST

Patent Literature 1: JP2000-252179A

### SUMMARY OF THE INVENTION

However, even when process parameters are adjusted based on the manufacturing conditions and control values of the manufacturing device and the inspection results of the manufactured products to determine the cause-and-effect relationship, as in Patent Literature 1, there are cases in which the desired characteristics, etc. cannot be obtained. This problem is particularly noticeable, for example, in the case of Nd—Fe—B sintered magnets, ferrite sintered magnets, and injection molded rare earth bonded magnets, which are manufactured through many processes and the semi-finished products obtained in each process take a variety of forms.

Therefore, the present invention provides a process estimation device and a process estimation method to estimate a more stable manufacturing process.

To solve the problems described above, one aspect of the invention provides a process estimation device using a computer, comprising:
a regression model creation processing unit that, in manufacturing a product through a plurality of manufacturing processes, defines a given manufacturing process, excluding a first manufacturing process, as a target process to be subject to process estimation, learns a relationship between at least a processing object data indicating a state of a processing object to be processed in the target process, a processed object data indicating a state of a processed object processed in the target process, a device condition data indicating a state of a device used for processing in the target process before processing, and a process data indicating a set value of manufacturing conditions of the target process by machine learning, and creates a regression model representing a correlation between the data; and a process estimation processing unit that estimates the process data to be estimated using the regression model created by the regression model creation processing unit.

To solve the problems described above, another aspect of the invention provides a computer-performed process estimation method, comprising:
in manufacturing a product through a plurality of manufacturing processes, defining a given manufacturing process, excluding a first manufacturing process, as a target process to be subject to process estimation;
learning a relationship between at least a processing object data indicating a state of a processing object to be processed in the target process, a processed object data indicating a state of a processed object processed in the target process, a device condition data indicating a state of a device used for processing in the target process before processing, and a process data indicating a set value of manufacturing conditions of the target process by machine learning;
creating a regression model representing a correlation between the data; and
estimating the process data to be estimated using the regression model.

### Advantageous Effects of the Invention

According to the invention, it is possible to provide a process estimation device and a process estimation method to estimate a more stable manufacturing process.

### BRIEF DESCRIPTION OF DRAWINGS

FIG. 1 is a schematic diagram of a process estimation device.

FIG. 2 is an explanatory diagram of the data used for process estimation.

FIG. 3 is a diagram showing an example of the overall database in the case of manufacturing ferrite magnets.

FIG. 4 is a diagram showing an example of the overall database in the case of manufacturing bonded magnets.

FIG. 5A is an explanatory diagram of the training data extraction process. FIG. 5B is an explanatory diagram of the regression model creation process.

FIG. 5C is an explanatory diagram of the process estimation process.

FIG. 6 is a flow chart of the process estimation method.

FIG. 7 is a flow chart of the data acquisition process.

FIG. 8A is a flow chart of the regression model creation process.

FIG. 8B is a flow chart of the process estimation process.

FIG. 9A is a diagram showing an example of a combination of parameters for the processing object data and the processed object data when the sintering process in manufacturing ferrite magnets is a target process.

FIG. 9B is a diagram showing an example of a combination of parameters for the processing object data and the processed object data when the processing process in manufacturing ferrite magnets is a target process.

FIG. 10 is a diagram showing an example of a combination of parameters for the processing object data and the processed object data when the injection molding process in manufacturing ferrite magnets is a target process.

FIG. 11A is a diagram showing an example of a variable setting screen.

FIG. 11B is a diagram showing an example of an evaluation value display screen.

FIG. 12A is a diagram showing an example of the estimation source data input screen.

FIG. 12B is a diagram showing an example of the estimation result display screen.

### DETAILED DESCRIPTION OF THE INVENTION

### Embodiment

An embodiment of the invention will be described below in conjunction with the appended drawings.

### SUMMARY OF THE INVENTION

For example, Nd—Fe—B sintered magnets and ferrite sintered magnets (hereinafter simply referred to as “ferrite magnets”) are manufactured by powder metallurgy, and a wide variety of processes are applied throughout the manufacturing process. For example, ferrite magnets are manufactured through a number of processes, including calcining, fine grinding, molding, sintering (firing), and processing processes. The final product, the ferrite magnet, must meet specifications such as product appearance, crushing strength, and dimensions, in addition to predetermined magnetic properties.

In general, it is important to minimize the variation of semi-finished products obtained in each manufacturing process in order to manufacture products stably. However, in the case of ferrite magnets, for example, it is sometimes difficult to optimize the process to reduce the variation of semi-finished products because the semi-finished products obtained in each process go through various forms: lumps (after the calcining process), fine powder slurry (after the fine grinding process), compacts (after the molding process) and sintered compacts (after the sintering process). Therefore, it was sometimes difficult to optimize the process in order to reduce the variation of semi-finished products. The same is true for injection molded bonded magnets, for example, in the case of rare earth magnets, where products are obtained through various forms in each process, such as the preparation of magnet alloys, milling of magnet alloys, mixing with resins and additives, kneading, and injection molding.

Therefore, in order to stabilize the manufacture, the inventor has studied intensively the method of process estimation that can reduce the variation of the processed object obtained after processing in any given process, even if the condition of the processing object (the object to be processed, i.e., semi-finished product) before processing in any given process fluctuates.

As a result, the inventor has found that if the condition of the processing object before processing in each process varies, the desired quality of the processed object cannot be obtained in a stable manner. This is thought to be because if the condition of the processing object before processing (e.g., larger or smaller than usual dimensions, rough surface, etc.) differs in any given process, the resulting processed object will vary unless the processing which takes this into consideration in the relevant process.

In other words, even if a process is estimated using a regression model created by machine learning using the process data of the manufacturing device used in the target process, the state of the manufacturing device, and the data of the product processed in the process, without considering the state of the processing object, as in the conventional art, the estimated process may not be appropriate according to the state of the processing object, and stable manufacturing may be difficult. In contrast, the present invention aims to stabilize the manufacture by estimating the process in consideration of the condition of the processing object before processing.

(Overall Configuration)

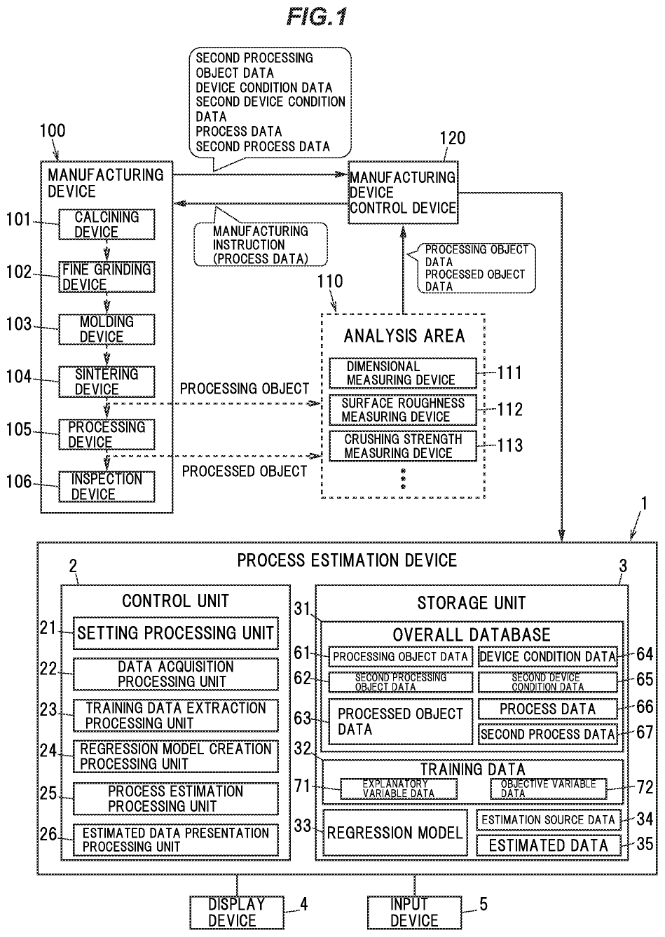

FIG. 1 is a schematic diagram of a process estimation device 1 using a computer. In this embodiment, the case in which the product to be manufactured by the process estimation device 1 is a ferrite magnet is described. Not limited to this, the product manufactured by the process estimation device 1 may be a Nd—Fe—B sintered magnet, an injection molded bonded magnet (rare earth bonded magnet or ferrite bonded magnet), etc. In addition to the process estimation device 1, FIG. 1 also shows a manufacturing device 100 for manufacturing ferrite magnets and an analysis area 110 for analyzing the processing object or processed object, as described below.

(Manufacturing Device 100)

The manufacturing device 100 is a device for producing ferrite magnets and is equipped with a calcining device 101 for the calcining process, a fine grinding device 102 for the fine grinding process, a molding device 103 for the molding process, and a sintering device 104 for the sintering process, a processing device 105 for the processing process such as dimensional adjustment, and an inspection device 106 that inspects the product. However, the manufacturing device 100 is not limited to those shown in the drawings, and the device configuration should be appropriate for the product to be manufactured.

In the calcining device 101, the mixed powder is heated to react the elementary materials to obtain a calcinated body with a microstructure (i.e., structure) consisting mainly of magnetoplumbite-type crystalline phase (M phase), which is the main phase of ferrite magnets. In the fine grinding unit 102, the calcinated body is coarsely milled and then finely grinded to obtain a powder that typically consists mainly of particles of 1 μm or less. By reducing the powder particle size, it becomes easier to orient the fine powder in the next process of molding in a magnetic field, making it easier to increase the remanence (i.e., residual magnetic flux density), and the main phase crystal grains as the final magnet are also finer, making it easier to increase the coercive force (coercivity).

In the molding device 103, the powder obtained in the fine grinding unit 102 is placed in a mold and compressed into a compacted powder. In this process, an external magnetic field is applied to align the orientation of the individual particles (easy direction of magnetization), resulting in high properties after sintering. The main molding method used in the molding device 103 is “wet molding,” in which a slurry of fine powder (ferrite powder) obtained in the fine grinding device 102 mixed with water is introduced into the molding die, and pressure is applied while a magnetic field is applied to drain water out of the slurry. The other is “dry molding,” in which the material is placed in a mold in a fine powder state without water added, subjected to a magnetic field, and pressurized. The molding method in the molding device 103 is not particularly limited, but “wet molding” is easier to orient the particles and obtain higher magnetic properties. In the sintering device 104, the molded body (i.e., compact) obtained in the molding device 103 is placed in a sintering furnace and heated to progress the reaction and densify the molded body. In the processing device 105, the sintered body obtained in the sintering device 104 is processed into the required shape and dimensions. The inspection device 106 inspects the product obtained in the processing device 105. By the above method, ferrite magnets are manufactured.

(Manufacturing Device Control Device 120)

The manufacturing device control device 120 is a device that gives manufacturing instructions and various settings to each of the devices 101 to 106 of the manufacturing device 100, monitors the production status of each of the devices 101 to 106, and collects various data during production, etc. The manufacturing device control device 120 is composed of a personal computer, for example. Although a single manufacturing device control device 120 is provided for each of the devices 101 to 106 here, it is possible to provide a specialized (i.e., dedicated) control unit for each of the devices 101 to 106, and to enable mutual communication of various data between the dedicated control unit and the manufacturing device control device 120. Data may also be exchanged between the manufacturing device control device 120 and each of the devices 101 to 106 using a USB memory or other storage medium.

The manufacturing device control device 120 receives the processing object data 61 and the processed object data 63 from the analysis area 110, as well as the second processing object data 62, the device condition data 64, the second device condition data 65, the process data 66, and the second process data 67 from the manufacturing device 100 (however, the second processing object data 62 may be received from the analysis area 110). If the manufacturing device control device 120 has process information, etc. of the target process (in this case, the processing process) as setting information, manufacturing instruction information, etc., it may be configured to acquire the information it owns as the process data 66. The manufacturing device control device 120 transmits each data received to the process estimation device 1. The details of each data are described below.

Further, the manufacturing device control device 120 is configured to output manufacturing instructions (set values in each process) to the manufacturing device 100, in such a manner that the process data estimated by the process estimation device 1 (the estimated data 35 described below) can be reflected in the process of the manufacturing device 100. In this embodiment, various data are transmitted to the process estimation device 1 via the manufacturing device control device 120, but it can also be configured to output data directly from the manufacturing device 100 or the analysis area 110 to the process estimation device 1. In addition, a management device for managing each of data 61 to 67 for machine learning may be provided separately from the manufacturing device control device 120, and the management device may be configured to transmit each of data 61 to 67 to the process estimation device 1 from the management device.

(Analysis Area 110)

The analysis area 110 is an area for analyzing the processing objects before processing in the target process and the processed objects processed in the target process, when the process to be estimated is the target process. The example in FIG. 1 shows the case where the target process is a processing process. In this case, the sintered body obtained by the sintering device 104 is the processing object, and the processed product is the product processed by the processing device 105. When the target process is the processing process, for example, in the analysis area 110, a dimensional measuring device 111 for measuring the dimensions of each part of the processing object and the processed object, a surface roughness measuring device 112 for measuring the surface roughness of the processing object and the processed object, and a crushing strength measuring device 113 for measuring the crushing strength of the processing object and the processed object are used. The processing object data 61, which is data indicating the state of the processing object, and the processed object data 63, which is data indicating the state of the processed object, obtained in the analysis area 110 are input to the process estimation device 1 via the manufacturing device control device 120. The “area” of the analysis area 110 does not represent a specific location, but is a conceptual area that groups together devices and other device for analysis. In other words, each device for analysis need not be located together in one place.

(Details of Various Data and Definitions of Words and Phrases)

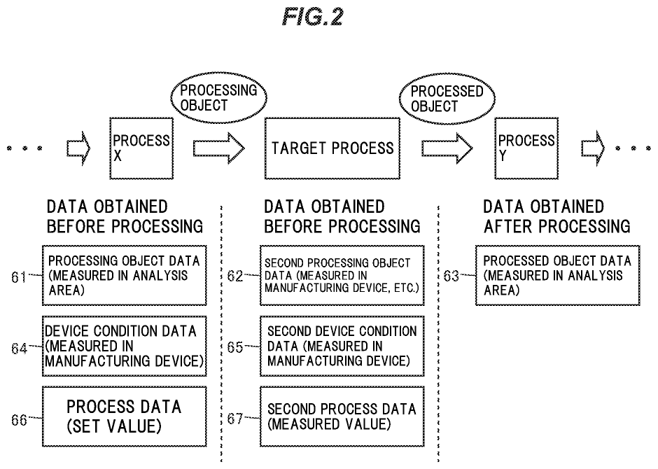

FIG. 2 is an explanatory diagram of the data used for process estimation in the present embodiment. As shown in FIG. 2, in this specification, the process subject to the process estimation is referred to as the target process, the semi-finished product (intermediate product) before processing in the target process is called the processing object, and the semi-finished product or product after processing in the target process is called the processed object. The processing object in the target process corresponds to the processed object in the process one step before the target process. Similarly, the processed object in the target process corresponds to the processing object in the process after the target process, or to the final product. Since the target process is the process to be performed on the processing object, the target process is the process excluding the first manufacturing process, i.e., the intermediate process or the final process. In the case of manufacturing ferrite magnets or bonded magnets as products, the processing object is ceramic or magnetic material.

The data obtained before the target process is processed include the processing object data 61, the device condition data 64, and the process data 66. These processing object data 61, device condition data 64, and process data 66, and processed object data 63, which is obtained after processing the target process, are essential data in the present embodiment.

The processing object data 61 is data indicating the state of the processing object to be processed in the target process and includes information on the characteristics, microstructure, composition, etc. of the processing object. More precisely, the processing object data 61 includes physical quantity data, which is data of physical quantity indicating the state of the processing object, industrial quantity data, which is data of industrial quantity indicating the state of the processing object, microstructure data, which is data indicating the state of the microstructure of the processing object, and composition data, which is data indicating the composition of the processing object. A “physical quantity” here refers to a quantity that has a fixed dimension under a certain theoretical system in physics and can be expressed as a multiple of a defined unit, and includes, for example, dimensions such as length and thickness, weight (mass), density, pH, electrical resistance, resistivity, specific surface area, magnetic flux density, magnetization (magnetic polarization), etc. An “industrial quantity” is an industrially useful quantity defined by an agreed upon measurement method, and includes, for example, powder average particle size, surface roughness, flatness, parallelism, chamfer amount, remanence, coercive force, viscosity, friction coefficient, bending strength, hardness, etc. Psychophysical quantity data, which are quantities that are psychologically meaningful and can be defined and measured physically in one-to-one correspondence with sensations under specific conditions such as luminous intensity, color, sound, etc., are known, but in this embodiment, these psychophysical quantity data are treated as industrial quantity data. The microstructure data includes the constituent phases, phase ratios, crystal grain size, etc. of the processing object.

The composition data includes the composition of the entire processing object, and, in the case of multiple materials, the composition (blended amount) of each material. The composition during each process deviates from the initial composition for various reasons. For example, in the case of Nd—Fe—B sintered magnets, it is known that the amount of Nd decreases during the fine grinding process. In other words, the composition data is data that varies from process to process and is treated as the processing object data 61 in the present embodiment.

If using all of the physical quantity data, industrial quantity data, microstructure data, and composition data as the processing object data 61 would result in over-learning, which would reduce the accuracy of process estimation, it is recommended that one to three of the four data (physical quantity data, industrial quantity data, microstructure data, and composition data) be used as the processing object data 61 for machine learning. In this case, it is recommended to use one or more and three of less of the four types of data as the processing object data 61. It is also desirable to use at least one of the physical quantity data and industrial quantity data as the processing object data 61. In other words, one or more and three or less of the data including at least one of physical quantity data or industrial quantity data out of the four data consisting of physical quantity data, industrial quantity data, microstructure data, and composition data should be used as the processing object data 61.

The processed object data 63 is the processing object data 61 for the next process, and like the processing object data 61, it contains one or more of the following data: physical quantity data, industrial quantity data, microstructure data, and composition data. When the target process is a processing process, the processed object data 63 includes information such as the dimensions and surface roughness of the processed object.

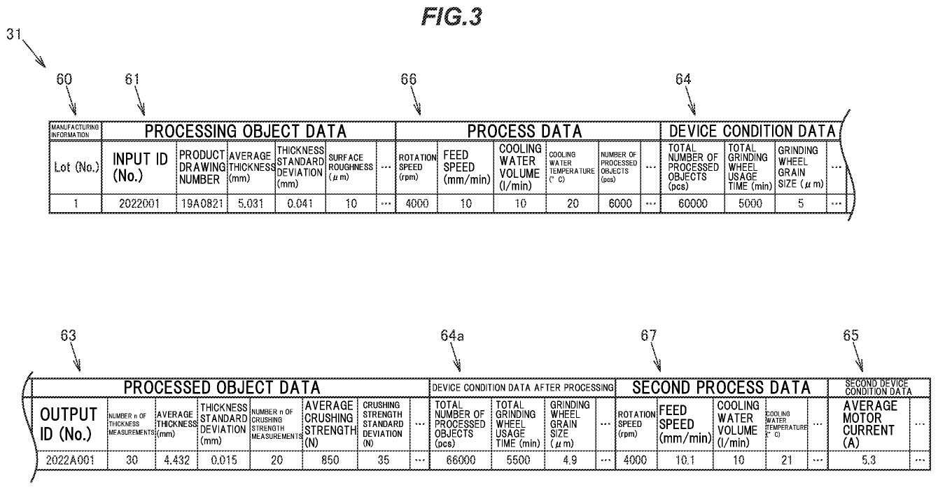

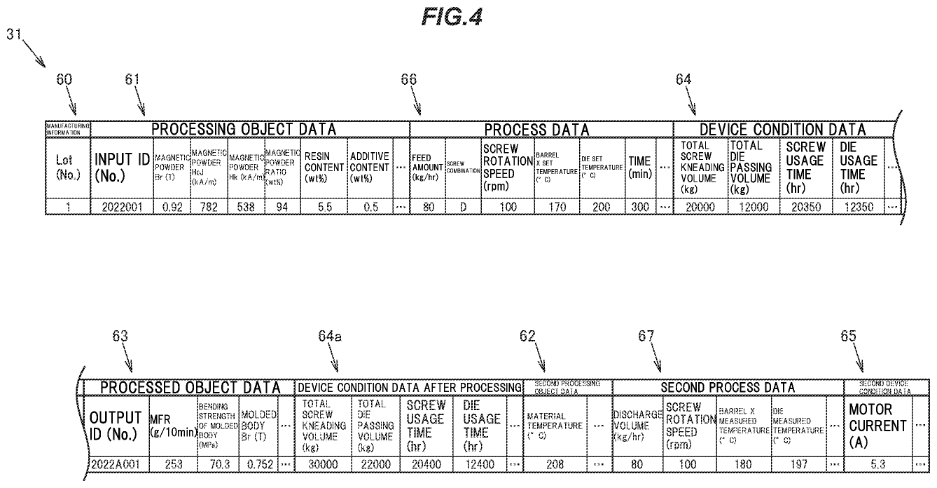

The device condition data 64 is data indicating the state of the device used for processing in the target process (in the example in FIG. 1, the processing device 105) before processing. In addition to data indicating the state of the device, such as the time of use of the device, the device condition data 64 may include consumable parts data indicating the state of consumable parts of the device (e.g., wear state and time of use of consumable parts). The process data 66 is data indicating the set values of manufacturing conditions for the target process, such as the rotation speed (i.e., the number of revolutions) of the grinding wheel. In this system, a post-processing device condition data 64a is also obtained for the same parameters as the device condition data 64 (see FIGS. 3 and 4). The post-processing device condition data 64a can be used as the device condition data 64 for the next manufacturing. Therefore, by acquiring the post-processing device condition data 64a, the data acquisition of the device condition data 64 before processing can be omitted.

The data obtained during the processing of the target process includes the second processing object data 62, the second device condition data 65, and the second process data 67. It is not mandatory to use these second processing object data 62, second device condition data 65, and second process data 67 for machine learning. However, including these data in machine learning can improve the accuracy of process estimation.

The second processing object data 62 is data indicating the state of the processing object being processed in the target process, such as temperature, phase change, shrinkage, etc. during processing. The second processing object data 62 may be obtained, for example, by removing a portion of the object being processed and analyzing it in the analysis area 110 during processing, or it may be measured by a temperature sensor or other sensor attached to the device.

The second device condition data 65 is data indicating the condition of the device during the processing in the target process. For example, it is information of actual measured values (i.e., measured values) indicating the condition of the device during the processing, such as motor drive current, torque, heater output value, and temperature distribution in the furnace. The second process data 67 is the measured values corresponding to the set values of the process data 66.

(Process Estimation Device 1)

Returning to FIG. 1, the process estimation device 1 includes at least a control unit 2, a storage unit 3, and a communication unit (not shown). The control unit 2 comprehensively controls the entire process estimation device 1, and the storage unit 3 stores information, etc. necessary for the various processes described below by the control unit 2. The process estimation device 1 is, e.g., a computer such as a server device, and is equipped with an arithmetic element such as a CPU, memory such as RAM and ROM, storage such as a hard disk, and a communication interface that is a communication device such as a LAN card.

The control unit 2 has a setting processing unit 21, a data acquisition processing unit 22, a training data extraction processing unit 23, a regression model creation processing unit 24, a process estimation processing unit 25, and an estimated data presentation processing unit 26. Details of each part are described below.

The storage unit 3 is realized by a predetermined storage area of a memory or storage device. The process estimation device 1 further includes a display device 4 and an input device 5. The display device 4 is, for example, a liquid crystal display, and the input device 5 is, for example, a keyboard and a mouse. The display device 4 may be configured as a touch panel, and the display device 4 may also serve as the input device 5. The display device 4 and input device 5 may be configured separately from the process estimation device 1 and be capable of communicating with the process estimation device 1 through wireless communication or other means. In this case, the display device 4 or input device 5 may comprise a portable terminal such as a tablet or smartphone.

(Setting Processing Unit 21)

The setting processing unit 21 performs setting processing for various settings of the process estimation device 1. The setting processing unit 21 can, for example, set information pertaining to various controls, such as the method of data acquisition by the data acquisition processing unit 22 and the setting of the data acquisition date and time. In addition, the setting processing unit 21 can register, update, delete, etc., various information to be stored in the storage unit 3. An input device 5 or the like can be used to input various information, etc.

(Data Acquisition Processing Unit 22)

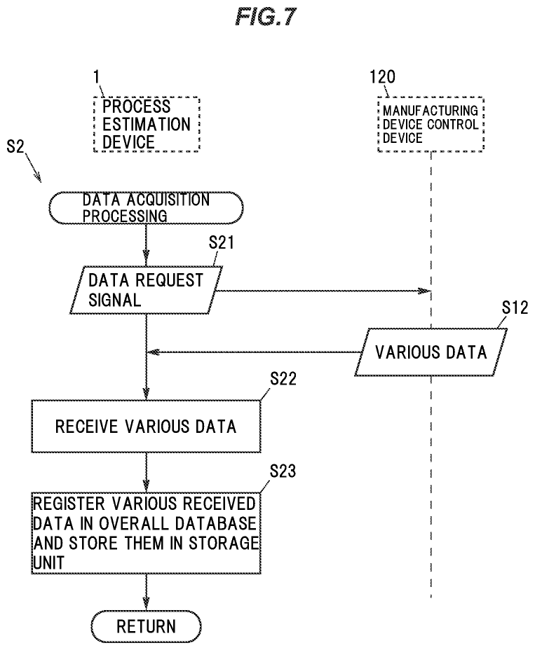

The data acquisition processing unit 22 performs data acquisition processing (see FIG. 7) to acquire each of the data 61 to 67 from the manufacturing device control device 120. The data acquisition processing unit 22 performs data acquisition processing when it receives a data update signal from the manufacturing device control device 120. In the data acquisition process, the data acquisition processing unit 22 sends a data request signal to the manufacturing device control device 120, receives each of the data 61 to 67 transmitted from the manufacturing device control device 120 accordingly, and stores them in the storage unit 3 as the overall database 31.

(Overall Database 31)

Here, the overall database 31 will be explained. FIG. 3 is a diagram showing an example of the overall database 31. Note that FIG. 3 shows the concept of the overall database 31 and does not describe the actual experimental data. As shown in FIG. 3, the overall database 31 is a database that collectively manages the collected data, and includes each data acquired from the manufacturing device control device 120, namely, the processing object data 61, processed object data 63, device condition data 64, second device condition data 65, process data 66, and second process data 67. In the example shown in the drawing, in addition to these data, the manufacturing information 60 and the post-processing device condition data 64a are also included in the overall database 31. In FIG. 3, since the processing process is the target process, the second processing object data 62 during processing is not included, but for example, if the target process is the sintering process, etc., the temperature, etc. during processing may be included as the second processing object data 62.

Each data item (parameter) in FIG. 3 is only an example and can be changed as needed depending on the target process or target product, the configuration of the manufacturing device 100, and the analysis device used in the analysis area 110. The overall database 31 may also include data not used for machine learning.

FIG. 3 shows an example of the overall database 31 in the case of manufacturing ferrite magnets. For example, the overall database 31 for bonded magnets formed by injection molding is shown in FIG. 4. As in FIG. 3, FIG. 4 shows the concept of the overall database 31, and does not describe actual experimental data, and each data item can be changed as needed.

(Training Data Extraction Processing Unit 23)

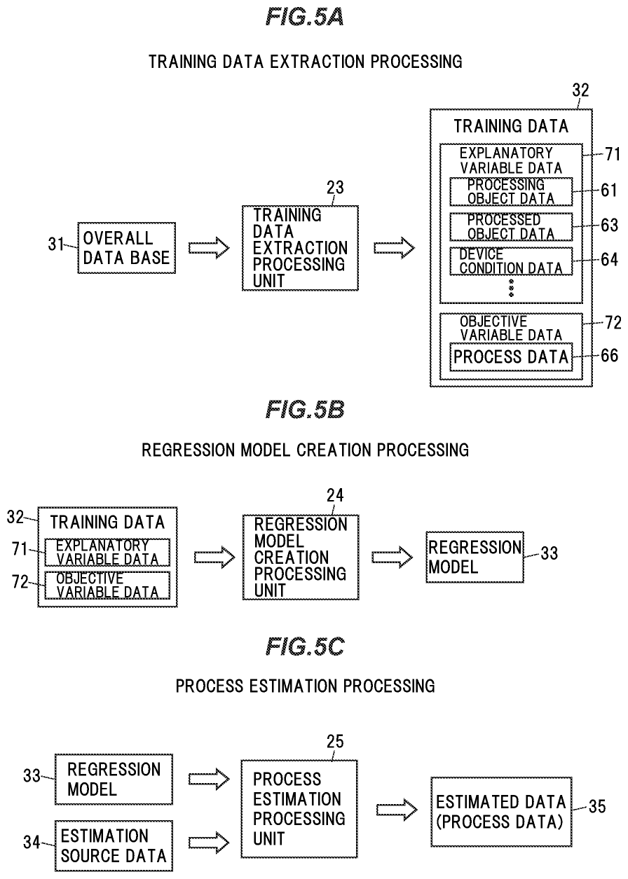

The training data extraction processing unit 23 extracts only the data to be used for machine learning from the overall database 31 as the training data 32. As shown in FIG. 5A, in the training data extraction process, the explanatory variable data 71 (explanatory variables) and the objective variable data 72 (objective variables) are extracted from the data contained in the overall database 31. In this process, the processing object data 61, the processed object data 63, the device condition data 64, etc. are used as explanatory variable data 71, and the process data 66 is used as the objective variable data 72. The extracted training data 32 is stored in the storage unit 3.

(Regression Model Creation Processing Unit 24)

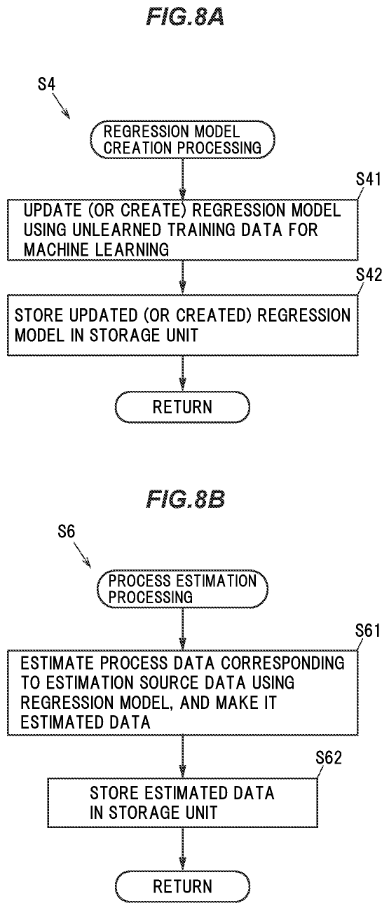

As shown in FIG. 5B, the regression model creation processing unit 24 performs machine learning using the extracted training data 32 to create a regression model 33 that shows the correlation between each parameter of the explanatory variable data 71 and each parameter of the objective variable data 72 (see FIG. 8A). In this process, the regression model creation processing unit 24 machine-learns at least the relationship between the processing object data 61, the processed object data 63, the device condition data 64, and the process data 66, and creates the regression model 33 that shows the correlation of these data.

The regression model creation processing unit 24 includes software such as a learning algorithm for learning the correlation of the parameters of the objective variable data 72 with respect to each parameter of the input explanatory variable data 71 by itself through machine learning. The learning algorithm is not particularly limited, and any known learning algorithm can be used, such as so-called deep learning using a neural network with three or more layers. What the regression model creation processing unit 24 learns corresponds to a model structure that represents the correlation between the explanatory variable data 71 and the objective variable data 72.

More specifically, the regression model creation processing unit 24 iteratively (repetitively) executes learning based on a data set containing the explanatory variable data 71 and the objective variable data 72, based on the input training data 32, and automatically interprets the correlation between the two data. Although the correlation is unknown at the start of learning, the correlation of the objective variable data 72 with respect to the explanatory variable data 71 is gradually interpreted as the learning proceeds, and the resulting learned model, i.e., the regression model 33, is used to allow for the interpretation of the correlation between the explanatory variable data 71 and the objective variable data 72.

The regression model creation processing unit 24 stores the created regression model 33 in the storage unit 3. In the present embodiment, the regression model creation processing unit 24 updates the regression model 33 every time the overall database 31 is updated. However, the present invention is not limited to this, for example, when executing the process estimation process described below, the data updates may be learned together and the regression model 33 may be updated.

(Process Estimation Processing Unit 25)

The process estimation processing unit 25 performs process estimation processing to estimate the process data 66 as estimation target using the regression model 33 created by the regression model creation processing unit 24 (see FIG. 8B). As shown in FIG. 5C, the process estimation processing unit 25 obtains the estimated data 35 based on the regression model 33 created by the regression model creation processing unit 24 and the estimation source data 34, which is the data of the estimation source. The obtained estimated data 35 is stored in the storage unit 3. In the present embodiment, the estimated data 35 is used as the process data 66 in order to estimate the process. The estimation source data 34 will be data other than the process data 66 used for machine learning. The estimation source data 34 is input, for example, by the input device 5. The estimated data 35 (process data 66) obtained here represents the set values of the process conditions that can achieve the desired state of the processed object, taking into consideration the state of the processing object and the state of the device, which are input as the estimation source data 34.

(Estimated Data Presentation Processing Unit 26)

The estimated data presentation processing unit 26 performs estimated data presentation processing to present the estimated data 35. In the estimated data presentation process, for example, the estimated data 35 are displayed on the display device 4. The estimated data presentation process may also be configured to present data other than the estimated data 35, such as items used as the explanatory variable data 71 and the objective variable data 72.

(Process Estimation Method)

(Main Routine)

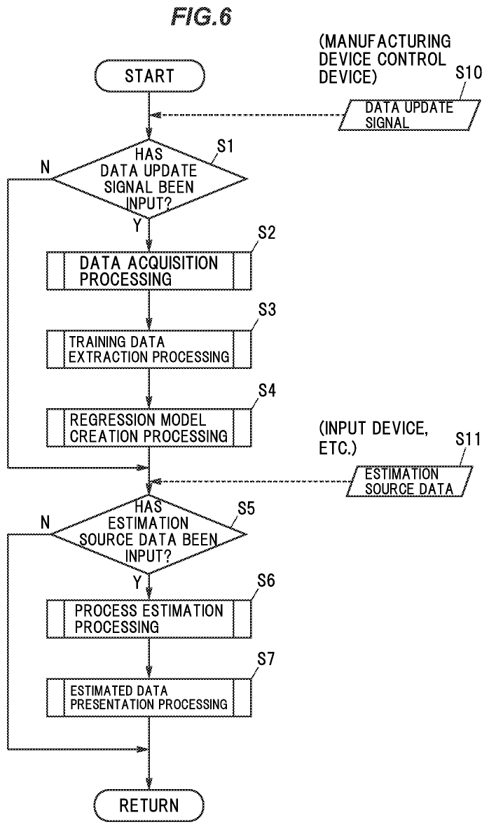

FIG. 6 is a flow diagram of a computer-performed process estimation method. In FIG. 6, the solid arrows represent the flow of control, and the dashed arrows represent the input and output of signals and data.

As shown in FIG. 6, when the manufacturing device control device 120 receives data from the manufacturing device 100 or the analysis area 110, it sends a data update signal to the process estimation device 1 (step S10). The process estimation device 1 determines in step S1 whether the data update signal has been input. If it is determined to be NO (N) in step S1, it proceeds to step S5. If YES (Y) is determined in step S1, it proceeds to step S2 to perform the data acquisition process.

In the data acquisition process of step S2, as shown in FIG. 7, the data acquisition processing unit 22 sends a data request signal to the manufacturing device control device 120 in step S21. The manufacturing device control device 120 that receives the data request signal transmits to the data acquisition processing unit 22 various data received from the manufacturing device 100 and the analysis area 110. Then, in step S22, the data acquisition processing unit 22 receives the various data. Then, in step S23, the data acquisition processing unit 22 registers the various data received into the overall database 31 and stores it in the storage unit 3. Thereafter, it returns and proceeds to step S3 in FIG. 6 to perform the training data extraction process.

In step S3, i.e., the training data extraction process, the training data extraction processing unit 23 extracts the explanatory variable data 71 and the objective variable data 72 from the overall database 31 and stores them in the storage unit 3 as the training data 32. Which data is used as the explanatory variable data 71 and the objective variable data 72 may be set by the user on a setting screen or the like. Details on this point are described below.

Then, in step S4, the regression model creation process is performed. In the regression model creation process, as shown in FIG. 8A, first, in step S41, the regression model creation processing unit 24 updates the regression model 33 using the unlearned training data 32 (the explanatory variable data 71 and the objective variable data 72 extracted in step S3) for machine learning. If the regression model 33 has not yet been created, step S41 is used to create a new regression model 33. Then, in step S42, the updated (or created) regression model 33 is stored in the storage unit 3 and returns.

When estimating a process, the estimation source data 34 is input by the input device 5 or other devices (step S11). The data to be used as the estimation source data 34 may be input to the process estimation device 1 in advance, and the input device 5 may be configured to select the data to be used as the estimation source data 34.

In step S5, the control unit 2 determines whether the estimation source data 34 has been input. If NO (N) is determined in step S5, it returns (returns to step S1). If YES (Y) is determined in step S5, it proceeds to step S6.

In step S6, the process estimation processing is performed. In the process estimation process, as shown in FIG. 8B, first, in step S61, the process estimation processing unit 25 estimates the process data 66 corresponding to the estimation source data 34 using the regression model 33, and makes the estimated data 35. Then, in step S62, the obtained estimated data 35 is stored in storage unit 3. It then returns and proceeds to step S7 in FIG. 6.

In step S7, the estimated data presentation process is performed. In the estimated data presentation process, for example, the estimated data presentation processing unit 26 presents the estimated data 35 estimated in step S6 by displaying the estimated data 35 on the display device 4. After that, it returns (returns to step S1).

Although not shown in the drawing, after the estimated data presentation process, the estimated data 35 may be sent to the manufacturing device control device 120 by the instruction of the user to give manufacturing instructions to the manufacturing device 100.

(The Method of Selecting the Processing Object Data 61)

The processing object data 61 is data that represents the state of the processing object and includes various parameters. What specific parameters are used for machine learning as the processing object data 61 can be determined according to the processed object data 63. The processed object data 63 used as the estimation source data 34 when performing process estimation is the target value for obtaining such a processed object after the target process. Therefore, in order to perform appropriate process estimation, it is desirable to determine the processing object data 61 according to the processed object data 63, including the required characteristics.

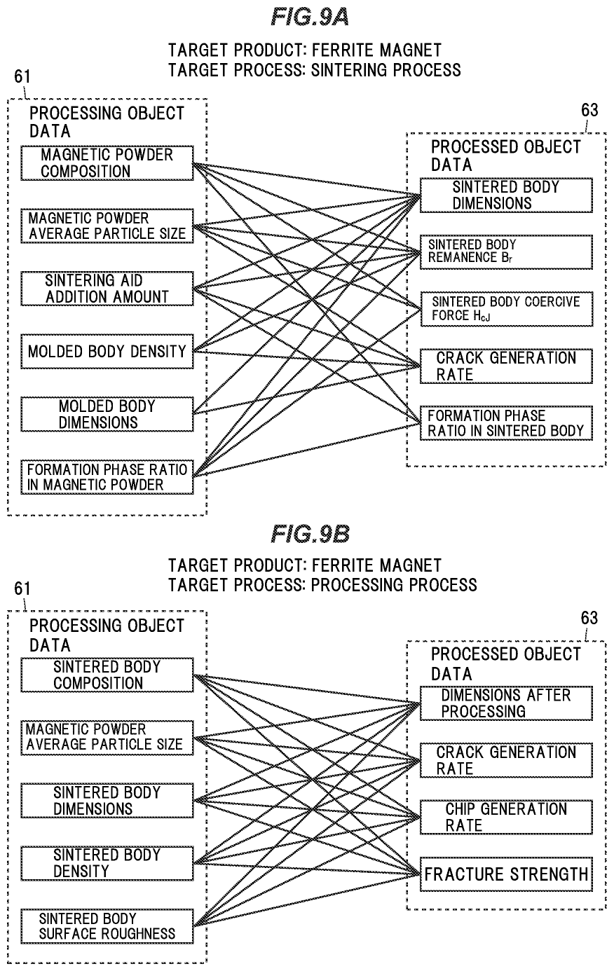

FIG. 9A shows the combination of each parameter of the processed object data 63 and the parameters of the processing object data 61 that should be used when the sintering process in the manufacture of ferrite magnets is used as the target process. As shown in FIG. 9, for example, when the sintered body residual magnetic flux density Br is used as the processed object data 63, it is desirable to use the parameters of powder composition, powder average particle size, sintering aid added amount, and ratio of formation phases in powder as the processing object data 61.

Similarly, FIG. 9b shows the combination of the parameters of the processed object data 63 and the processing object data 61 when the sintering process in the manufacture of ferrite magnets is the target process. As shown in FIG. 9B, in the processing process, the parameters of the processed object data 63 include dimensions after processing, crack generation rate, chip generation rate, and fracture strength, etc. When all of these are used as the processed object data 63, it is desirable to use all the parameters on the left side of the drawing, namely, sintered body composition, powder average particle size, sintered body dimensions, sintered body density, and sintered body surface roughness as the processed object data 63.

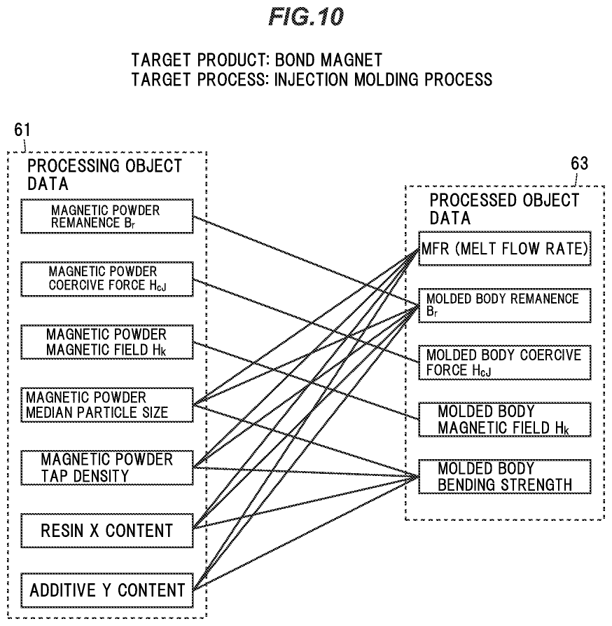

Furthermore, FIG. 10 shows a desirable combination of the parameters of the processed object data 63 and the processing object data 61 when the injection molding process in the manufacture of bonded magnets is used as the target process. It is also possible to configure the control unit 2 in such a manner that the combination of the parameters of the processed object data 63 and the processing object data 61 as shown in FIGS. 9 and 10 is stored in the storage unit 3 in advance, and the appropriate parameters of the processing object data 61 are automatically selected according to the parameters of the processed object data 63 selected by the user. This allows the parameters of the processing object data 61 to be appropriately selected regardless of the skill and knowledge of the user, thereby suppressing over-learning due to the use of unnecessary parameters and further improving the accuracy of process estimation.

(Explanation of Various Screens)

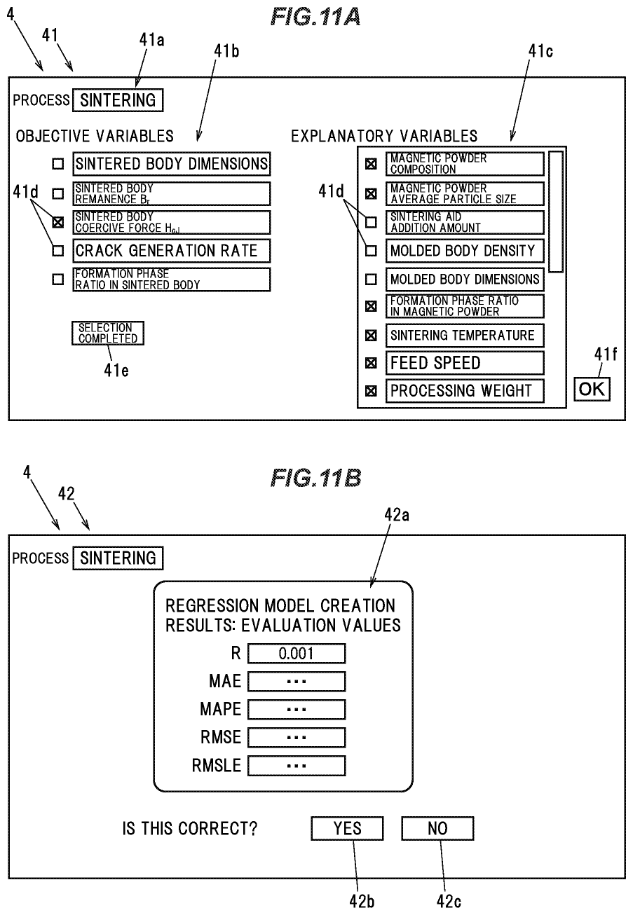

The various screens displayed on the display device 4 will now be explained. FIG. 11A shows an example of a variable setting screen 41 that is displayed when creating the regression model 33. As shown in FIG. 11A, the variable setting screen 41 has a process selection area 41a for selecting a process at the top of the screen, an objective variable selection area 41b for selecting an objective variable on the left side of the screen, and an explanatory variable selection area 41c for selecting an explanatory variable on the right side of the screen. The user first selects a process in the process selection area 41a. Then, the objective variables that can be selected for the process are displayed in the objective variable selection area 41b. Then, the user selects the objective variable by checking checkboxes 41d in the objective variable selection area 41b, and presses (clicks or touches) a selection completion button 41e. Then, the appropriate explanatory variable is displayed in the explanatory variable selection area 41c with the appropriate explanatory variable already checked according to the selected objective variable. The user decides which explanatory variable to use by adding or unchecking the checkboxes 41d in the explanatory variable selection area 41c, and then presses an OK button 41f. Then, based on the selection results, the above training data extraction processing and the regression model creation processing are performed, and the regression model 33 is created.

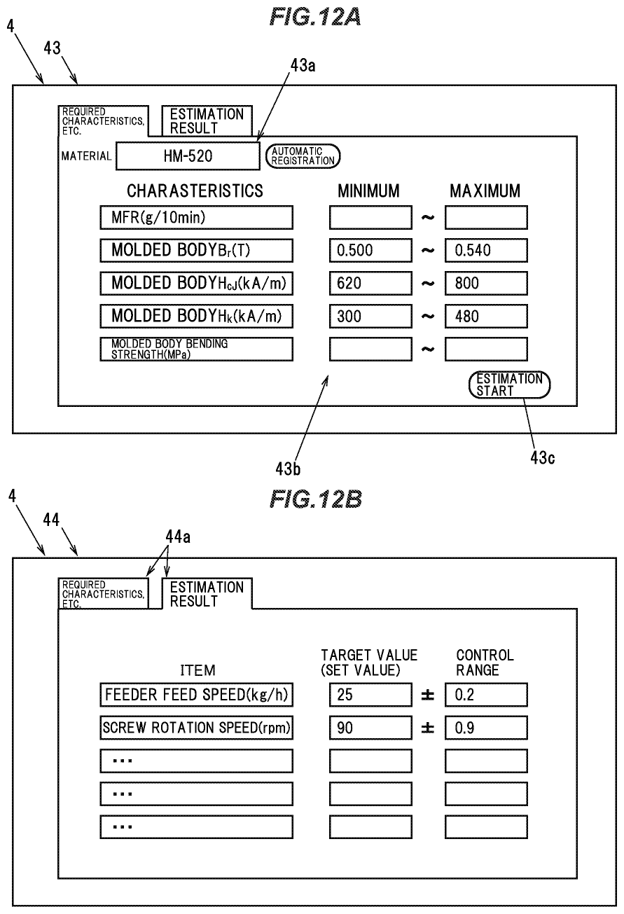

Although not mentioned above, if, for example, too many explanatory variables are used, the estimation accuracy of the regression model 33 may decrease due to over-training. Therefore, in this study, the control unit 2 is configured to create the regression model 33 using a portion (e.g., 70%) of the training data 32, conduct a test using the remaining portion (e.g., 30%) of the training data 32, and display the evaluation values on the display device 4. FIG. 11B shows an example of an evaluation value display screen 42 indicating the evaluation values. As shown in FIG. 11B, the evaluation value display screen 42 has an evaluation value display area 42a in the center of its screen, where the evaluation value is displayed. Which evaluation value is used can be changed as needed. At the bottom of the evaluation value display screen 42, a message prompting confirmation, such as “Is this correct?” is displayed. If a Yes button 42b is pressed, for example, the screen transits to an estimation source data input screen 43 (see FIG. 12A), where the estimation source data is input. If a No button 42c is pressed, the screen returns to the variable setting screen 41 in FIG. 11B, and the objective variables and the explanatory variables to be used are set once again. By repeating the selection and evaluation of the objective variables and the explanatory variables to be used, the appropriate objective variables and explanatory variables can be selected and the estimation accuracy can be improved.

FIG. 12A shows an example of an estimation source data input screen 43. As shown in FIG. 12A, the estimation source data input screen 43 has a material selection area 43a for selecting a material and an input area 43b for inputting data for the estimation source data 34. For example, when the user selects a material in the material selection area 43a, the values corresponding to the material may be automatically entered in the input area 43b. In the illustrated example, the minimum and maximum values are input in the input area 43b, but it may be configured in such a manner that only one value (representative value) is input. When input to the input area 43b is completed and an estimation start button 43c is pressed, the process estimation process described above will be performed.

FIG. 12B shows an example of an estimation result display screen 44, which displays estimation results of the process estimation process. As shown in FIG. 12B, the estimation result display screen 44 displays a target value (set value) for each item. These target values are the estimated data 35 estimated by the process estimation process. Here, the target value and control range are displayed, but for example, the control range may be omitted. For the control range, different values may be set for positive and negative values. The estimation result display screen 44 has a tab 44a at the top, and by pressing the tab 44a for “Demand characteristics, etc.,” the user can return to the estimation source data input screen 43 in FIG. 12A and change input data, etc.

The screens shown in FIGS. 11A, 11B, 12A and 12B are only examples, and the display layout, display items, display format, etc. can be changed as necessary.

(Function and Effect of the Embodiment)

As explained above, in the process estimation device 1, in addition to the conventionally used processed object data 63, device condition data 64, and process data 66, machine learning is performed by considering the processing object data 61, which indicates the state of the processing object, and using the obtained regression model 33, the process data 66 as the estimation target is estimated.

By taking into account the processing object data 61, even if the state of the processing object has fluctuated due to some effect, it is possible to reduce the variation in the processed object obtained after processing in the target process, thus stabilizing the manufacture.

### Modified Example

In the above embodiment, the case of manufacturing magnets is described, but the product to be manufactured is not limited to this. For example, the product to be manufactured may be a resin composition used as a coating material for electric wires.

In the above embodiment, the processing object data 61, the processed object data 63, and the device condition data 64, etc. were used as the explanatory variable data 71 and the process data 66 was used as the objective variable data 72, but the combination of the explanatory variable data 71 and the objective variable data 72 can be changed as needed. For example, it is possible to create the regression model 33 using the processing object data 61, device condition data 64, process data 66, etc. as the explanatory variable data 71 and the processing object data 63 as the objective variable data 72, and then estimate the process data 66 using this regression model 33.

In the above embodiment, only the point of estimating the process data 66 using the created regression model 33 was described, but the regression model 33 may be further converted to estimating other data, such as being able to estimate the characteristics of the processed object, etc. (i.e., processed object data 63) using the created regression model 33.

Furthermore, although not mentioned in the above embodiment, the overall database 31, the training data 32, or the estimated data 35 (the estimated process data 66) may contain data that should not be disclosed to users who do not need it, for reasons such as containing know-how. In such cases, it is more desirable to set access restrictions, for example, allowing access to each data stored in the storage unit 3 only to users who have administrative authority. If the estimated data 35 includes data to be withheld from disclosure, the estimated data presentation processing unit 26 may be configured in such a manner that the data is not presented on the display device 4, etc., or the data is presented only when operated by a user who has administrative authority.

### SUMMARY OF THE EMBODIMENT

Next, the technical concepts that can be grasped from the above embodiment will be described with the help of the codes, etc. in the embodiment. However, each sign, etc. in the following description is not limited to the members, etc. specifically shown in the embodiment for the constituent elements in the scope of claims.

According to the first feature, a process estimation device 1 includes a regression model creation processing unit 24 that, in manufacturing a product through a plurality of manufacturing processes, defines a given manufacturing process, excluding a first manufacturing process, as a target process to be subject to process estimation, learns a relationship between at least a processing object data 61 indicating a state of a processing object to be processed in the target process, a processed object data 63 indicating a state of a processed object having been processed in the target process, a device condition data 64 indicating a state of a device used for processing in the target process before processing, and a process data 66 indicating a set value of manufacturing conditions of the target process by machine learning, and creates a regression model 33 representing a correlation between the data; and a process estimation processing unit 25 that estimates the process data 66 to be estimated using the regression model 33 created by the regression model creation processing unit 24.

According to the second feature, in the process estimation device 1 as described in the first feature, the processing object data 61 includes at least one of physical quantity data that is data of physical quantity indicating a state of the processing object, industrial quantity data that is data of industrial quantity indicating a state of the processing object, microstructure data that is data indicating a state of a microstructure of the processing object, and composition data that is data indicating a composition of the processing object, wherein one or more and three or less of data including at least one of the physical quantity data or the industrial quantity data out of four data consisting of the physical quantity data, the industrial quantity data, the microstructure data, and the composition data is used for the machine learning.

According to the third feature, in the process estimation device 1 as described in the first or second feature, the regression model creation processing unit 24 further uses, as data for the machine learning, second processing object data 62 indicating a state of the processing object being processed in the target process.

According to the fourth feature, in the process estimation device 1 as described in any one of the first to third features, the regression model creation processing unit 24 further uses, as data for the machine learning, second device condition data 65 indicating a state of the device processing in the target process.

According to the fifth feature, in the process estimation device 1 as described in any one of the first to fourth features, the device condition data 64 includes consumable parts data indicating a state of consumable parts of the device.

According to the sixth feature, in the process estimation device 1 as described in any one of the first to fifth features, the processing object is a ceramic material.

According to the seventh feature, in the process estimation device 1 as described in any one of the first to sixth features, the processing object is a magnetic material.

According to the eighth feature, a computer-performed process estimation method includes, in manufacturing a product through a plurality of manufacturing processes, defining a given manufacturing process, excluding a first manufacturing process, as a target process to be subject to process estimation, learning a relationship between at least a processing object data 61 indicating a state of a processing object to be processed in the target process, a processed object data 63 indicating a state of a processed object having been processed in the target process, a device condition data 64 indicating a state of a device used for processing in the target process before processing, and a process data 66 indicating a set value of manufacturing conditions of the target process by machine learning; creating a regression model 33 representing a correlation between the data; and estimating the process data 66 to be estimated using the regression model 33.

Although the embodiment of the invention has been described, the invention according to claims is not to be limited to the embodiment described above. Further, please note that not all combinations of the features described in the embodiment are necessary to solve the problem of the invention. In addition, the invention can be appropriately modified and implemented without departing from the gist thereof.

1. A process estimation device using a computer, comprising:
a regression model creation processing unit that, in manufacturing a product through a plurality of manufacturing processes, defines a given manufacturing process, excluding a first manufacturing process, as a target process to be subject to process estimation, learns a relationship between at least a processing object data indicating a state of a processing object to be processed in the target process, a processed object data indicating a state of a processed object having been processed in the target process, a device condition data indicating a state of a device used for processing in the target process before processing, and a process data indicating a set value of manufacturing conditions of the target process by machine learning, and creates a regression model representing a correlation between the data; and
a process estimation processing unit that estimates the process data to be estimated using the regression model created by the regression model creation processing unit.

2. The process estimation device according to claim 1, wherein the processing object data comprises at least one of:
physical quantity data that is data of physical quantity indicating a state of the processing object,
industrial quantity data that is data of industrial quantity indicating a state of the processing object,
microstructure data that is data indicating a state of a microstructure of the processing object, and
composition data that is data indicating a composition of the processing object, wherein one or more and three or less of data including at least one of the physical quantity data or the industrial quantity data out of four data consisting of the physical quantity data, the industrial quantity data, the microstructure data, and the composition data is used for the machine learning.

3. The process estimation device according to claim 1, wherein the regression model creation processing unit further uses, as data for the machine learning, second processing object data indicating a state of the processing object being processed in the target process.

4. The process estimation device according to claim 1, wherein the regression model creation processing unit further uses, as data for the machine learning, second device condition data indicating a state of the device processing in the target process.

5. The process estimation device according to claim 1, wherein the device condition data includes consumable parts data indicating a state of consumable parts of the device.

6. The process estimation device according to claim 1, wherein the processing object is a ceramic material.

7. The process estimation device according claim 1, wherein the processing object is a magnetic material.

8. A computer-performed process estimation method, comprising:
in manufacturing a product through a plurality of manufacturing processes, defining a given manufacturing process, excluding a first manufacturing process, as a target process to be subject to process estimation;
learning a relationship between at least a processing object data indicating a state of a processing object to be processed in the target process, a processed object data indicating a state of a processed object having been processed in the target process, a device condition data indicating a state of a device used for processing in the target process before processing, and a process data indicating a set value of manufacturing conditions of the target process by machine learning;
creating a regression model representing a correlation between the data; and
estimating the process data to be estimated using the regression model.
